(19) United States
(12) Patent Application Publication
(10) Pub. No.: US 2026/0158654 A1
(43) Pub. Date: Jun. 11, 2026

(54) ROUTE GENERATING DEVICE, ROUTE GENERATING METHOD, AND RECORDING MEDIUM

(71) Applicant: KONICA MINOLTA, INC., Tokyo (JP)

(72) Inventor: Yoshihiko YOSHIZAKI, Okazaki-shi (JP)

(73) Assignee: KONICA MINOLTA, INC., Tokyo (JP)

(21) Appl. No.: 19/408,405

(22) Filed: Dec. 4, 2025

(30) Foreign Application Priority Data
Dec. 9, 2024 (JP) 2024-214578

(51) Int. Cl. B25J 9/16

(52) U.S. Cl. CPC B25J 9/1666; B25J 9/161

(57) ABSTRACT

A route generating device including a hardware processor that calculates a motion route including a plurality of sections for a robot to which a plurality of arms are operatively connected, and that is able to individually set whether or not to protect a calculation result of the motion route by the hardware processor in the plurality of sections when the calculation result exists.

### CROSS-REFERENCE TO RELATED APPLICATIONS

The entire disclosure of Japanese Patent Application No. 2024-214578 filed on Dec. 9, 2024 is incorporated herein by reference in its entirety.

### BACKGROUND OF THE INVENTION

### Technical Field

The present disclosure relates to a route generating device, a route generating method, and a recording medium that calculates a motion route of a robot.

### Description of Related Art

In recent years, teaching for setting a motion route of a robot is performed on a computer (see, for example, Japanese Unexamined Patent Publication No. 2019-214084 and Japanese Unexamined Patent Publication No. 2023-062543). In this case, a working environment of the robot is reproduced on a computer, a motion route connecting the plurality of target positions is calculated, and the obtained motion route is transferred to a robot controller to perform operation control of the robot.

In the calculation of the motion route, for example, a random sampling-base route search method such as RRT (Rapidly-exploring Random Tree) is widely used.

sampling-based route search method such as RRT (Rapidly-exploring Random Tree) is widely used. This is a method in which via-points are defined at random and a tree of via-points is extended so that a collision with an obstacle does not occur until two target positions are connected.

### SUMMARY OF THE INVENTION

However, in the calculation of the motion route in the related art, even when only some of the results do not satisfy the user, it is necessary to execute the recalculation over the entire section. In other words, the recalculation is executed for a section for which the recalculation is originally unnecessary, and the calculation time is unnecessarily required.

In particular, in the route search method base on random sampling, the calculation result may not be reproduced (see FIGS. 7 and 8). Therefore, in a case where a part that the user cannot be satisfied with is included in the motion route of the calculation result, when the part is recalculated, there is a risk that the part that the user has been satisfied with will also change.

The present disclosure has been made in view of the above circumstances, and an object of the present disclosure is to suitably execute recalculation of a motion route of a robot.

To achieve at least one of the abovementioned objects, according to an aspect of the present invention, route generating device reflecting one aspect of the present invention comprises:

a hardware processor
that calculates a motion route including a plurality of sections for a robot to which a plurality of arms are operatively connected, and
that is able to individually set whether or not to protect a calculation result of the motion route by the hardware processor in the plurality of sections when the calculation result exists.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a robot apparatus according to an embodiment;

FIG. 2 is a block diagram illustrating a schematic control configuration of the robot apparatus according to the embodiment;

FIG. 3 is a flowchart illustrating a sequence of route generation processing according to the embodiment;

FIG. 4 is an example of display on the display part in the route generation processing according to the embodiment, and is a diagram illustrating a main screen displayed in the route generation processing;

FIG. 5 is a view illustrating an option setting screen which is an example of display on a display part in route generation processing according to the embodiment and is displayed in the route generation processing;

FIG. 6 is an example of display on the display part in the route generation processing according to the embodiment, and is a diagram illustrating a main screen displayed in the route generation processing;

FIG. 7 is a diagram illustrating that a calculation result is not reproduced with a route search method base on random sampling; and

FIG. 8 is a diagram showing that the calculation result is not reproduced in the route search method based on random base sampling.

### DETAILED DESCRIPTION

Hereinafter, one or more embodiments of the present invention will be described with reference to the drawings. However, the scope of the invention is not limited to the disclosed embodiments.

### Configuration of Robot Apparatus

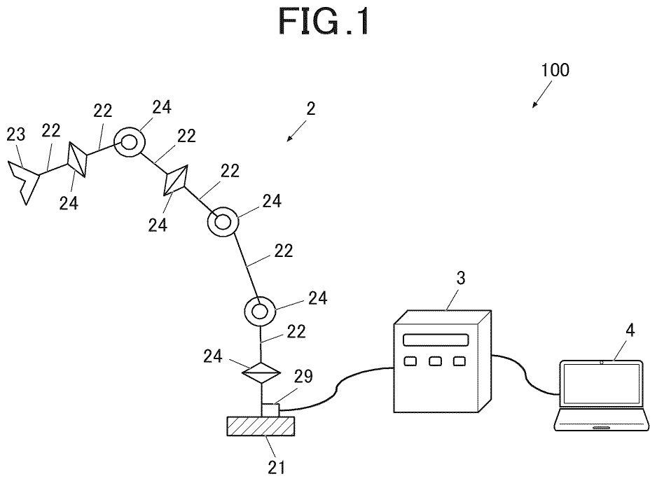

FIG. 1 is a view illustrating the robot apparatus 100 according to the present embodiment.

As illustrated in this figure, the robot device 100 includes a robot main body 2, a robot controller 3, and a control device 4.

The robot main body 2 corresponds to an example of a robot according to the present disclosure, and is a vertical articulated robot in the present embodiment. Specifically, the robot main body 2 includes a plurality of arms 22, an end effector 23, a plurality of joints 24, and a servo control device 29.

The plurality of arms 22 are connected to each other in series with the base portion 21, which is fixed to an environment (e.g., a floor surface) not illustrated, as a base end portion.

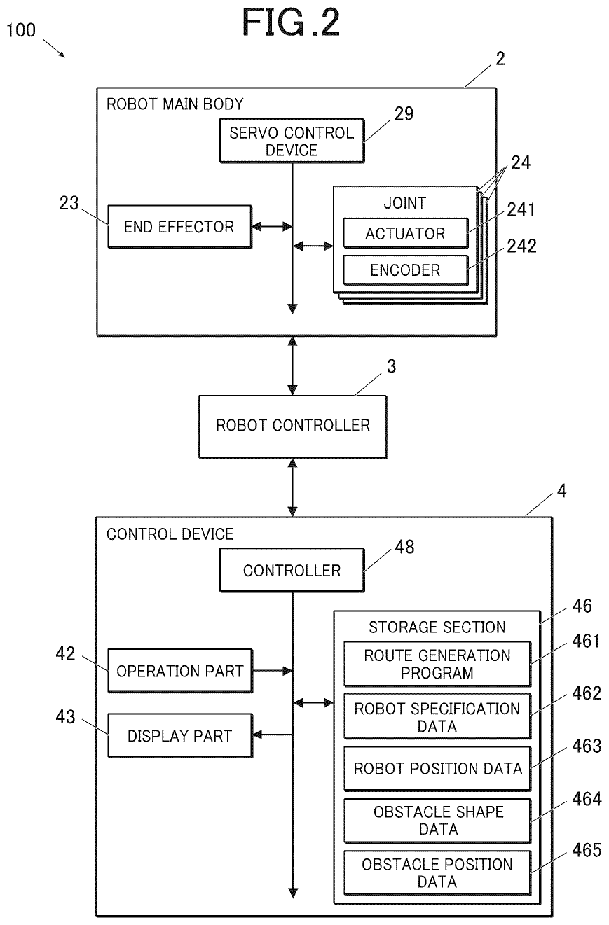

The plurality of joints 24 rotatably connects the base 21, the plurality of arms 22, and the end effector 23. Each of the joints 24 is provided with an actuator 241 for driving the joint 24, and an encoder 242 for detecting the position (speed) of the actuator 241 and outputting it to the robot controller 3 (see FIG. 2).

The end effector 23 is connected to distal ends of the plurality of arms 22.

The servo control device 29 controls the operation of the actuator 241 that drives each joint 24.

The robot controller 3 controls the operation of each part of the robot main body 2 based on a control command from the control device 4. Specifically, the robot controller 3 outputs a position command to the servo control device 29 of the robot main body 2 at predetermined time intervals, and outputs information detected by each encoder 242 to the control device 4.

FIG. 2 is a block diagram illustrating a schematic control configuration of the robot device 100.

As illustrated in this figure, the control device 4 is a computer that controls the entire robot apparatus 100 including teaching of the robot main body 2. The control device 4 is not particularly limited, but is, for example, a notebook PC, a tablet, or a smartphone. The control device 4 corresponds to an example of a route generating device according to the present disclosure.

Specifically, the control device 4 includes the operation part 42, a display part 43, a storage section 46, and a controller 48 (hardware processor).

The operation part 42 is operation means by which a user (an operator of the robot main body 2) performs various operations (inputs) for operating the control device 4. The operation part 42 includes, for example, a pointing device such as a mouse and a keyboard.

The display part 43 is, for example, a liquid crystal display, an organic electroluminescence display, or another display, and displays various kinds of information based on a display signal from the controller 48. Note that the display part 43 may be a touch screen (touch screen) that also serves as part of the operation part 42, or may output sound.

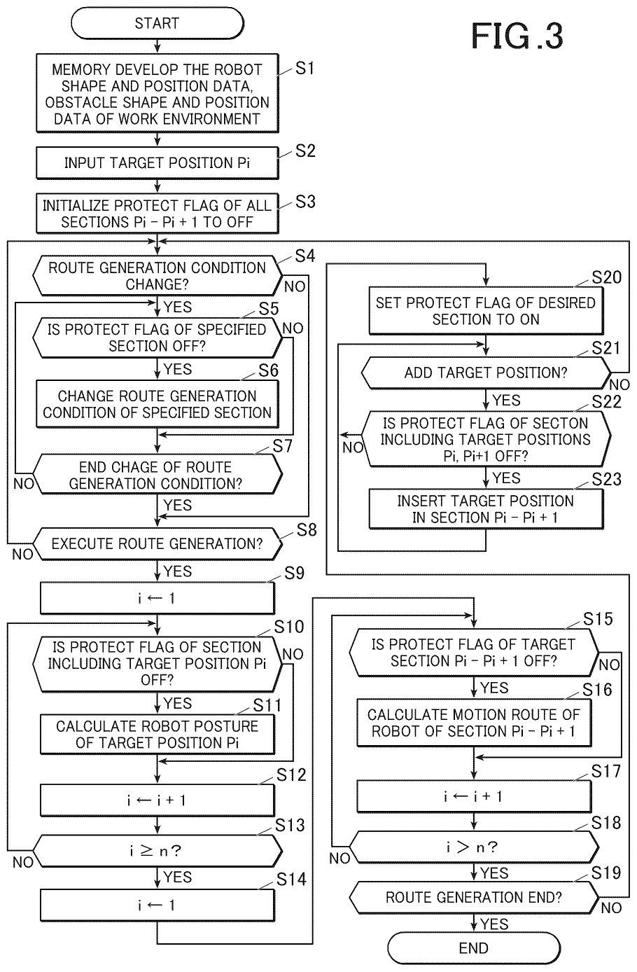

The storage section 46 is a memory including, for example, a random access memory (RAM), a read only memory (ROM), and the like. The storage section 46 stores various programs and data, and also functions as an operating area for the controller 48. In the storage section 46 of the present embodiment, a route generation program 461 for executing a route generation process (refer to FIG. 3) to be described later is stored in advance.

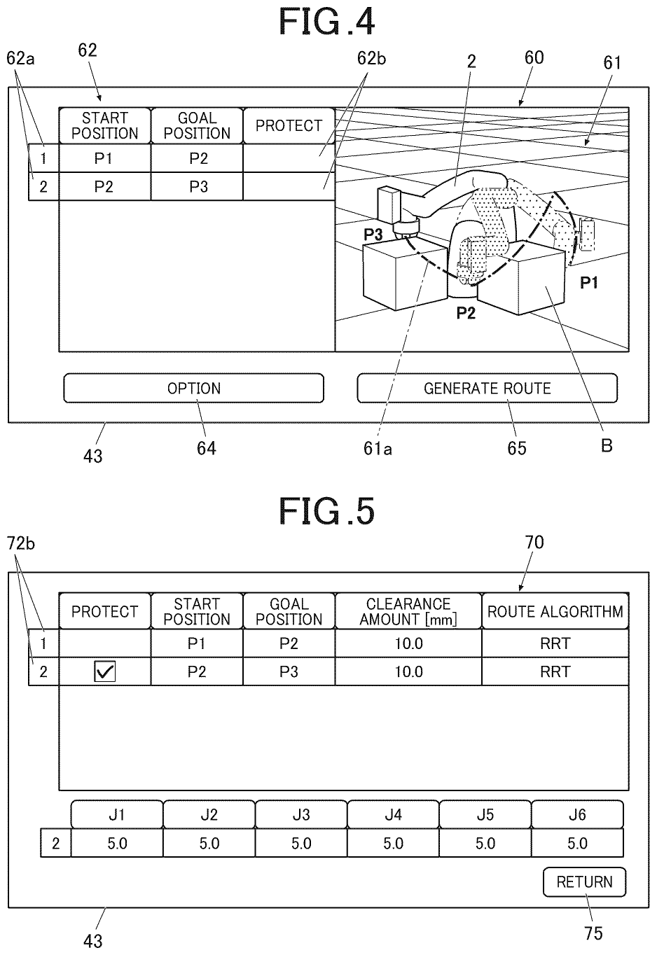

Robot specification data 462, robot position data 463, obstacle shape data 464, and obstacle position data 465 are stored in advance in the storage section 46. The robot specification data 462 includes information regarding various specifications and shapes of the robot main body 2, such as the length and the movable range of each joint 24. The robot position data 463 includes information on the installation position of the robot main body 2 in the work environment. The obstacle shape data 464 includes information on a size and a shape of an obstacle B (see FIG. 4 and the like) which is present in the operation range of the robot main body 2 and can hinder the operation of the robot main body 2. The obstacle position data 465 includes information on the installation position of the obstacle B in the work environment.

The controller 48 is configured to include, for example, a central processing unit (CPU), a graphics processing unit (GPU), or the like, and controls the operation of each unit of the control device 4. Specifically, based on operation content of the operation part 42, the controller

48 causes the display part 43 to display various information, develops a program stored in advance in the storage section 46, and executes various processing in cooperation with the developed program.

### Route Generation Processing

Subsequently, route generation processing for generating an motion route of the robot main body 2 will be described.

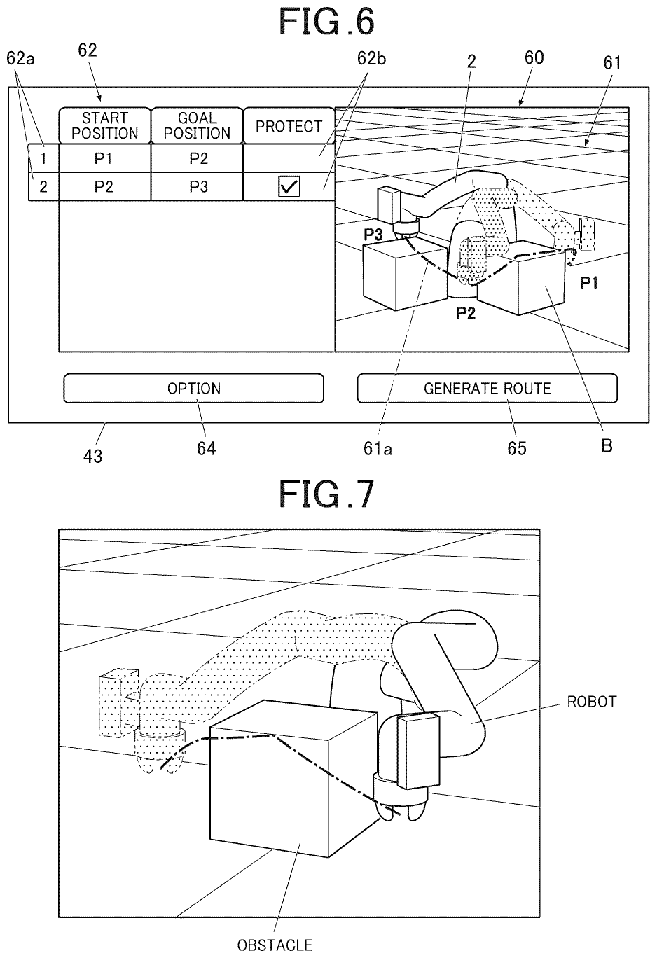

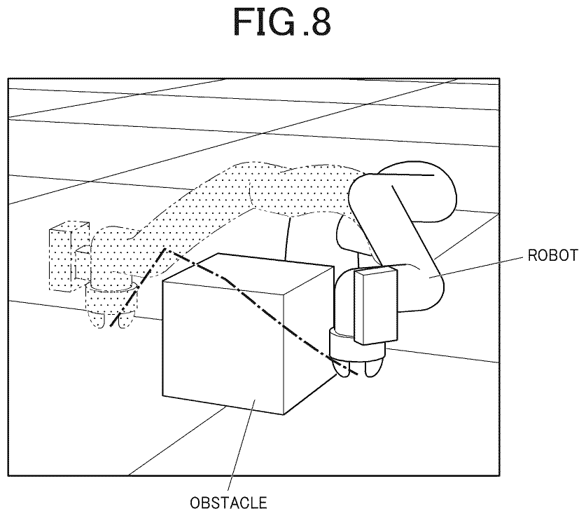

FIG. 3 is a flowchart illustrating a sequence of route generation processing, and FIGS. 4 to 6 are diagrams illustrating display examples of the display part 43 in the route generation processing. Among these, FIGS. 4 and 6 illustrate a main screen 60 which is displayed in the route generation processing, and FIG. 5 illustrates a setting screen 70.

The route generation process is a process of generating a motion route of the robot main body 2 connecting a plurality of target positions (movement target positions of the end effector 23) based on the teaching operation of the user. The information on the “motion route” includes angle information on each of the joints 24. The route generation process is executed by the controller 48 reading and expanding the route generation program 461 from the storage section 46 based on a user operation on the control device 4.

As illustrated in FIG. 3, when the route generation processing is executed, first, the controller 48 reads information on the shapes and positions of the robot main body 2 and the obstacle B from the storage section 46, develops the information, and causes the display part 43 to display the information (step S1).

Here, the controller 48 reads information on the shape and position of the robot main body 2 from the robot specification data 462 and the robot position data 463 in the storage section 46. Further, the controller 48 reads information on the shape and the position of the obstacle B from the obstacle shape data 464 and the obstacle position data 465 in the storage section 46.

At this time, for example, as illustrated in FIG. 4, the controller 48 causes the display part 43 to display a main screen 60 which is a main graphical user interface (GUI) of the route generation program 461. The main screen 60 includes a model display area 61 and a route display area 62.

In the model display area 61, CG (Computer Graphics)

models of the robot main body 2 and the obstacle B are displayed. The CG model is two dimensionally or three dimensionally displayed on the basis of information on the shapes and the positions of the robot main body 2 and the obstacle B. The CG model can be arbitrarily moved, resized, and rotated. Further, in the model display area 61, as will be described later, when a motion route of the robot main body 2 is calculated, a movement route line 61a which is a movement trajectory of the end effector 23 is displayed on the CG model as a set of via-points.

In the route display area 62, the movement route of the end effector 23 is displayed as a list of section display fields 62a having information of sections obtained by dividing the movement route. In the section display field 62a, section numbers of the sections assigned in ascending order, start positions and goal positions of the sections, and a protect field 62b are displayed.

The protect field 62b indicates whether or not the section is protected. Here, to “protect” a section means to, in a case where a calculation result of a motion route of the robot main body 2 in the section exists, prevent the calculation result from being changed. The “change of the calculation result” includes a change of information and a condition that affect the calculation result, and in the present embodiment, includes a change of the route generation condition and division of the section (addition of the target position).

The protect field 62b is also a GUI for receiving a protection setting operation by the user, and is a checkbox in the present embodiment. The protect field 62b indicates “ON/OFF” of a protect flag depending on whether the field is checked or not (see FIG. 6). Protection of the section is enabled when the protect flag is “ON”, and protection of the section is disabled when the protect flag is “OFF”. The protect flag can be set to “ON” in step S20 described below, based on a user operation.

In addition, an option button 64 for transitioning to a setting screen 70, which will be described later, and a route generation button 65 for executing route generation are displayed on the main screen 60.

The display content of the main screen 60 is not particularly limited as long as the display content includes at least the information of the motion route of the robot main body 2.

Next, the controller 48 inputs a target position (movement target position) of the end effector 23 based on a user operation (step S2). The target position includes a start position and a goal position in each section of the movement route of the end effector 23.

Here, the user operates, for example, the operation part 42 to operate the end effector 23 of the robot main body 2 of the CG model, thereby inputting desired n target positions P i (i=1 to n). The controller 48 sets n-1 sections from the target position Pn (start position) to the target position Pn+1 (goal position) as the nth section, and causes the set information to be displayed in the route display area 62.

At this time, the controller 48 initializes the protect flags in all the sections to “OFF (invalid)” (step S3).

Next, the controller 48 determines whether or not to change the route generation condition based on the user operation (step S4).

The route generation conditions are calculation conditions for calculating the motion route of the robot main body 2. The route generation condition of the present embodiment includes a minimum clearance amount between the robot main body 2 and the obstacle B, a route planning algorithm used for route search, and a margin amount of a movable limit of each joint 24 (see FIG. 5). The margin amount of the limitation on the movement of each joint 24 is a setting as to how much margin is allowed for the movement of the joint 24 relative to the maximum movable range (angle) in the specification of each joint 24.

In the present embodiment, for example, when the option button 64 is operated by the user, the controller 48 determines that the route generation conditions are to be changed.

When determining not to change the route generation conditions in step S4 (step S4; No), the controller 48 moves the process to step S8 described below.

On the other hand, when determining in step S4 to change the route generation conditions (step S4; Yes), the controller 48 determines whether the protect flag of the section specified to change the route generation conditions is “OFF” (step S5).

In step S5, when it is determined that the protect flag of the designated section is not “OFF” (step S5; No), the controller 48 shifts the process to step S7 described later. That is, in this case, since the protect flag for the section is “ON (valid)” and the section is protected, the route generation conditions for the section are not allowed to be changed.

On the other hand, when determining in step S5 that the protect flag for the section for which it is specified to change the route generation conditions is “OFF” (step S5; Yes), the controller 48 changes the route generation conditions for the section on the basis of a user operation (step S6).

In the present embodiment, for example, as shown in FIG. 5, the user can individually set the route generation condition in a plurality of sections on the setting screen 70. The setting screen 70 is displayed on the display part 43 when the button 64 is operated on the main screen 60. In the example of FIG. 5, the minimum clearance amount between the robot main body 2 and the obstacle B is set to “10 mm”, and the route planning algorithm is set to “RRT (Rapidly-exploring Random Tree)”. As the movable limit of the joint 24, an angle margin

of “5 deg” is set with respect to the maximum movable range in each joint 24 represented by attaching a prefix J to a number in ascending order from the base part 21 side of the robot main body 2.

Note that the route planning algorithm of the present embodiment is a route search method base on random sampling. Examples of the route search method based on random sampling base include RRT *, RRT connect, EET (Exploring/Exploiting Tree), and PRM (Probabilistic Roadmap Method), in addition to RRT. Provided that a base route search method other than the random sampling-based method may be applied.

route search method other than the random sampling-based method may be applied.

In addition, in the setting screen 70, a protect field 72b corresponding to the protect field 62b in the main screen 60 is displayed for each section. ON/OFF of the protect flag may be switchable in the protect field 72b of the setting screen 70.

Next, the controller 48 determines whether to end the changing of the route generation conditions (step S7) and, if determined not to end (step S7; No), moves the process to step S5 described above.

The controller 48 determines to end the change of the route generation condition, for example, when the user performs a transition operation from the setting screen 70 (for example, an operation of the return button 75).

On the other hand, when determining in step S7 to end the changing of the route generation conditions (step S7; Yes), the controller 48 determines whether to execute route generation (step S8). The controller 48 determines to execute the route generation when the user performs an execution operation of the route generation (for example, an operation of the route generation button 65).

In step S8, in a case where it is determined that the route generation is not executed (step S8; No), the controller 48 causes the process to proceed to step S4 described above.

On the other hand, in step S8, when it is determined that the route generation is executed (step S8; Yes), the controller 48 sequentially calculates the posture of the robot main body 2 at each target position Pi (steps S9 to S13). First, the controller 48 sets “i” to an initial value “1” (step S9).

Next, the controller 48 determines whether the protect flag of the section including the target position Pi is “OFF” (step S10), and when determining that it is “OFF” (step S10; Yes), obtains the posture of the robot main body 2 at this time (step S11). Specifically, the controller 48 calculates inverse kinematics for the target position Pi on the basis of the information on the shape and the position of the robot main body 2 and the information on the shape and the position of the obstacle B. Then, the controller 48 determines the posture of the robot main body 2 (the angle of each joint 24) that satisfies the clearance amount for avoiding the interference with the obstacle B and the margin amount of the movable limit of each joint 24. The controller 48 allows the obtained posture to be displayed in the model display area 61, for example, in a different display mode for each target position (see FIG. 4). Thereafter, the controller 48 increments i (step S12).

On the other hand, when it is determined in step S10 that the protect flag of the section including the target position Pi is not “OFF” (step S10; No), the controller 48 omits step S11 and increments i (step S12). In this case, since the protect flag of the section is “ON (valid)” and the section is protected, the calculation for obtaining the posture of the robot main body 2 is omitted.

Until “i≥n” is satisfied (step S13; Yes), the controller 48 repeats the processing of steps S10 to S12. Thus, the posture of the robot main body 2 at all the target positions Pi are calculated. The controller 48 allows the storage section 46 to store information on the calculated posture.

Next, the controller 48 calculates the motion route of the robot main body 2 in each section Pi−Pi+1 as follows: (step S14 to S18).

First, the controller 48 sets “i” to an initial value “1” (step S14).

Then, the controller 48 determines

whether the protect flag of the section Pi−Pi+1 is “OFF” or not (step S15), and when determining that the protect flag is “OFF” (step S15; Yes), the controller 48 obtains the motion route of the robot main body 2 in the section (step S16). To be specific, the controller 48 calculates the motion
route of the robot main body 2 in the section Pi−Pi+1 by using the posture of the robot main body 2 at the target positions Pi and Pi +1 and the set
route planning algorithm. As a result, a set of via-points through which the robot main body 2 moves while avoiding interference with the obstacle B, that is, the motion route of the robot main body 2, is calculated based on the route generation condition of the section. The controller 48 causes a movement trajectory of the end effector 23 in the obtained motion route to be displayed as a movement route line 61a in the model display area 61 (see FIG. 4). Thereafter, the controller 48 increments i (step S17).

On the other hand, when the controller 48 determines in step S15 that the protect flag of the section Pi−Pi+1 is not “OFF” (step S15; No), the controller 48 omits step S16 and increments i (step S17).

In this case, since the protect flag of the section is “ON (valid)” and the section is protected, the calculation for obtaining the motion route of the robot main body 2 is omitted.

The controller 48 repeats the processing of step S15 to step S17 until “i>n” is satisfied (step S18; Yes). Thus, the motion route of the robot main body 2 over all the sections is calculated. The controller 48 allows the storage section 46 to store information on the calculated motion route.

Next, the controller 48 determines whether or not to end the route generation processing based on a user operation (step S19). If the motion routes of all the sections include an unsatisfactory one, the user does not end the route generation processing and performs an execution operation for recalculation.

In this case, that is, in a case where it is determined not to end the route generation processing on the basis of the user operation (step S19; No), the controller 48 turns “ON” the protect flag of the section in which recalculation of the motion route is unnecessary on the basis of the user operation (step S20). In the present embodiment, the user checks the protect field 62b of the section to be protected (section display field 62a) in the route display area 62 of the main screen 60. Thus, as shown in FIG. 6, the calculation result of the section is protected. Note that the protect flag can be switched at an arbitrary timing before execution of calculation.

Next, the controller 48 determines whether or not to newly add (insert) a target position based on a user operation (step S21). For example, when the user wants to further divide the current section, the user designates a desired section and performs an operation of adding a target position.

Here, in a case where it is determined that the target position is to be added (step S21; Yes), the controller 48 determines whether or not the protect flag of the section designated by the user to add the target position is “OFF” (step S22).

When determining in step S22 that the protect flag of the specified section is not “OFF” (no in step S22), the controller 48 proceeds to the processing in step S21 described above. That is, in this case, since the protect flag of the section is “ON (valid)” and the section is protected, the section is not divisible and no target position is added to the section.

On the other hand, in step S22, when it is determined that the protect flag of the section designated to add the target position is “OFF” (step S22; Yes), the controller 48 adds the target position to the section based on the user operation (step S23). At this time, the controller 48 sets the protect flag of the section generated along with the addition of the target position to “OFF”, and increments the total number “n” of the target positions. Further, the controller 48 updates the display contents of the main screen 60 or the setting screen 70 in response to the change. Thereafter, the controller 48 proceeds to the above-described step S21.

In step S21, in a case where it is determined that a new target position is not added (step S21; No), the controller 48 causes the process to proceed to step S4 described above. Next, the controller 48 performs confirmation of route generation condition (step S4 to S7) and calculation for route generation (step S8 to S18).

In step S19 described above, when the user is satisfied with the motion routes of all the sections, the user performs an end operation of the route generation processing. In this case, that is, when it is determined to end the route generation processing on the basis of the user operation (step S19; Yes), the controller 48 ends the route generation processing.

### Technical Effects of the Present Embodiment

As described above, according to the present embodiment, in a case where a calculation result of a motion route of the robot main body 2 (robot) exists, whether to protect the calculation result can be individually set for a plurality of sections.

Therefore, setting protection of a calculation result for a section in which the user is satisfied with the calculation result can omit recalculation of a motion route for the section. Thus, since the recalculation can be executed only for the section that cannot satisfy the calculation result, the calculation time can be shortened compared with the case of executing the recalculation over the entire section.

Furthermore, in the case of the route search method based on random base sampling, there is a risk that the calculation result will not be reproduced. Therefore, in a case where a part that the user cannot be satisfied with is included in the motion route of the calculation result, when the part is recalculated over all the sections, there is a concern that even the part that the user has been satisfied with may change. In this regard, according to the present embodiment, by protecting the section in which the user is satisfied with the calculation result, it is possible to avoid a situation in which the calculation result of the section is changed by the recalculation.

Therefore, the recalculation of the motion route of the robot main body 2 can be suitably executed.

Furthermore, according to the present embodiment, if there is a section in which a calculation result is protected, route generation conditions for the protected section are not allowed to be changed.

Thus, for the protected section, the condition related to the calculation of the motion route is made unchangeable, and the calculation result can be reliably protected.

Furthermore, according to the present embodiment, when there is a section in which a calculation result is protected, the protected section is not allowed to be divided. That is, a new target position cannot be added to the protected section.

Thus, for the protected section, the condition related to the calculation of the motion route is made unchangeable, and the calculation result can be reliably protected.

Further, according to the present embodiment, the display part 43 displays the protect field 62b, which is a GUI for individually displaying whether or not a plurality of sections are protected and accepting a user's operation for setting the protection.

Accordingly, the user can immediately recognize the protection setting (ON/OFF) for each section by viewing the display part 43, and can easily switch the setting.

### Others

Although an embodiment of the present disclosure has been described, embodiments to which the present disclosure is applicable are not limited to the above embodiment and its modification examples. The embodiment can be appropriately modified without departing from the scope of the present disclosure.

For example, in the embodiment described above, the setting (ON/OFF) of protection for a section is displayed in the protect field of the route display area. However, the setting of protection may be displayed in the model display area. For example, the portion of the protected section of the movement route line 61a of the end effector 23 may be displayed in a different display mode from the other unprotected portion. Thus, the protected section can be easily recognized visually.

Furthermore, in the above embodiment, the control device 4 that controls the operation of the robot main body 2 has been described as an example of the route generating device according to the present disclosure. However, the route generating device according to the present disclosure may be any apparatus that can acquire information necessary for calculation, and may be a computer or the like that is not related to operation control of a robot that is a calculation target of a motion route.

In the above-described embodiment, the robot main body 2 of the vertical articulated robot is exemplified. However, the robot according to the present disclosure is not limited to the vertical articulated robot as long as a plurality of arms are operatively connected to each other.

According to the above embodiment, it is possible to suitably execute recalculation of the motion route of the robot.

Although embodiments of the present invention have been described and illustrated in detail, the disclosed embodiments are made for purposes of illustration and example only and not limitation. The scope of the present invention should be interpreted by terms of the appended claims.

What is claimed is:

1. A route generating device comprising a hardware processor
that calculates a motion route including a plurality of sections for a robot to which a plurality of arms are operatively connected, and
that is able to individually set whether or not to protect a calculation result of the motion route by the hardware processor in the plurality of sections when the calculation result exists.

2. The route generating device according to claim 1, wherein
the hardware processor calculates the motion route based on information on a shape and a position of the robot and information on a shape and a position of an obstacle existing in an operation range of the robot.

3. The route generating device according to claim 1, wherein
the hardware processor is able to individually set a route generation condition for calculating the motion route for the plurality of sections, and
when there is a section in which the calculation result is to be protected, the hardware processor makes the route generation condition of the section to be protected unchangeable.

4. The route generating device according to claim 3, wherein
the route generation condition includes information on a clearance amount between the robot and an obstacle, a route planning algorithm, and a movable range of a joint of the robot.

5. The route generating device according to claim 1, wherein
when there is a section for which the calculation result is to be protected, the hardware processor sets the section to be protected to be indivisible.

6. The route generating device according to claim 1, wherein
the hardware processor causes a display to display information related to the plurality of sections, and
the hardware processor causes the display to display a GUI that individually displays whether or not the plurality of sections are protected and receives a setting operation for protection by a user.

7. A route generating method comprising:
route generating that is calculating, by a hardware processor, a motion route including a plurality of sections for a robot to which a plurality of arms are operatively connected, and
protecting that is individually setting, by the hardware processor, whether or not to protect a calculation result of the motion route by the route generating in the plurality of sections when the calculation result exists.

8. A non-transitory computer-readable recording medium storing a route generation program that causes a computer to perform:
route generating that is calculating a motion route including a plurality of sections for a robot to which a plurality of arms are operatively connected, and
protecting that is individually setting whether or not to protect a calculation result of the motion route by the route generating in the plurality of sections when the calculation result exists.
